(19) United States
(12) Patent Application Publication
(10) Pub. No.: US 2026/0301247 A1
(43) Pub. Date: Oct. 1, 2026

(54) PARTITIONED GPU RECOLORING

(71) Applicant: InterDigital VC Holdings, Inc., Wilmington, DE (US)

(72) Inventors: Junghyun Ahn, New York, NY (US); Jiahao Pang, Plainsboro, NJ (US); Muhammad Asad Lodhi, Highland Park, NJ (US); Dong Tian, Boxborough, MA (US)

(21) Appl. No.: 19/090,047

(22) Filed: Mar. 25, 2025

(51) Int. Cl. G06T 11/00; G06T 1/20

(52) U.S. Cl. CPC G06T 11/10; G06T 1/20

(57) ABSTRACT

Some embodiments of a method may include: obtaining a slicing parameter; obtaining a target point cloud geometry; obtaining a reference point cloud geometry with attribute; partitioning the target point cloud, wherein partitioning the target point cloud comprises applying the slicing parameter and a set of partition parameters to the target point cloud; partitioning the reference point cloud, wherein partitioning the reference point cloud comprises applying the slicing parameter and the set of partition parameters to the reference point cloud; for each partition of the target point cloud: processing a GPU-based recoloring function with the corresponding partition of the reference point cloud to generate one or more partitioned and recolored point clouds; assembling the one or more partitioned and recolored point clouds; and outputting the one or more assembled point clouds.

### INCORPORATION BY REFERENCE

The present application incorporates by reference in its entirety the following application: U.S. Non-Provisional patent application Ser. No. 19/085,781, entitled “PARTITIONING METHOD FOR POINT CLOUD ATTRIBUTE CODING” and filed Mar. 20, 2025 (“781 application”).

### BACKGROUND

The present application is related to point clouds.

### SUMMARY

An example method in accordance with some embodiments may include: obtaining a slicing parameter; obtaining a target point cloud geometry; obtaining a reference point cloud geometry with attribute; partitioning the target point cloud, wherein partitioning the target point cloud includes applying the slicing parameter and a set of partition parameters to the target point cloud; partitioning the reference point cloud, wherein partitioning the reference point cloud includes applying the slicing parameter and the set of partition parameters to the reference point cloud; for each partition of the target point cloud: processing a GPU-based recoloring function with the corresponding partition of the reference point cloud to generate one or more partitioned and recolored point clouds; assembling the one or more partitioned and recolored point clouds; and outputting the one or more assembled point clouds.

Some embodiments of the example method may further include generating the set of partition parameters.

For some embodiments of the example method, partitioning the reference point cloud is performed before partitioning the target point cloud.

For some embodiments of the example method, obtaining the slicing parameter includes decoding the slicing parameter.

For some embodiments of the example method, wherein obtaining the slicing parameter includes obtaining a bitstream, and wherein the bitstream includes the slicing parameter.

For some embodiments of the example method, the target point cloud geometry includes at least one of: a predicted point cloud geometry of a current frame, a reconstructed point cloud geometry of the current frame, and an input point cloud geometry of the current frame.

Some embodiments of the example method may further include applying the one or more assembled point clouds to a predictive attribute decoder.

Some embodiments of the example method may further include: applying the one or more assembled point clouds to a predictive attribute encoder; and encoding the slicing parameters into a bitstream

For some embodiments of the example method, processing, for each partition of the target point cloud, the GPU-based recoloring function with the corresponding partition of the reference point cloud includes: splitting the GPU-based recoloring function into a series of split GPU-based recoloring functions corresponding respectively to the partitions of the reference point cloud; and generating a partitioned and recolored point cloud for each partition of the target point cloud.

For some embodiments of the example method, partitioning the reference point cloud includes: inputting the reference point cloud, the slicing parameter, and the set of partition parameters into a partitioning process; and partitioning the reference point cloud into a set of partitioned reference point clouds, wherein the slicing parameter indicates quantity of partitioned reference point clouds.

For some embodiments of the example method, partitioning the target point cloud includes: computing variance of geometry of the target point cloud; selecting boundary axes for the target point cloud using the computed variance; estimating boundaries for the target point cloud based on the selected boundary axes; and partitioning the target point cloud based on the estimated boundaries.

For some embodiments of the example method, computing variance of geometry of the target point cloud computes variance along x, y, and z axes of the target point cloud.

For some embodiments of the example method, selecting boundary axes includes selecting boundary axes corresponding to computed variances above a threshold.

For some embodiments of the example method, estimating boundaries for the target point cloud includes: determining a 50th percentile value along at least one of the selected axes, wherein the 50th percentile value splits the target point cloud into approximately equal numbers of points.

For some embodiments of the example method, partitioning the target point cloud includes: partitioning the target point cloud into a set of partitioned target point clouds, wherein the slicing parameter indicates quantity of partitioned target point clouds.

For some embodiments of the example method, the slicing parameter is an integer equal to 0, 1, 2, or 3.

For some embodiments of the example method, the GPU-based recoloring function includes: performing a first GPU-based nearest neighbor search from the reference point cloud to the target point cloud; performing a second GPU-based nearest neighbor search from the target point cloud to the reference point cloud; and performing a distance-based weighted attribute interpolation using nearest neighbor lists generated by the first and second GPU-based nearest neighbor searches.

For some embodiments of the example method, each of the first and second GPU-based nearest neighbor searches includes splitting each of the first and second searches to a plurality of sets of threads based on number of points to search in the target and reference point clouds.

For some embodiments of the example method, splitting each of the first and second searches to the plurality of sets of threads generates sets of threads of approximately equal size.

An example apparatus in accordance with some embodiments may include: a processor; and a memory storing instructions operative, when executed by the processor, to cause the apparatus to: obtain a slicing parameter; obtain a target point cloud geometry; obtain a reference point cloud geometry with attribute; partition the target point cloud, wherein partitioning the target point cloud includes applying the slicing parameter and a set of partition parameters to the target point cloud; partition the reference point cloud, wherein partitioning the reference point cloud includes applying the slicing parameter and the set of partition parameters to the reference point cloud; for each partition of the target point cloud: process a GPU-based recoloring function with the corresponding partition of the reference point cloud to generate one or more partitioned and recolored point clouds; assemble the one or more partitioned and recolored point clouds; and output the one or more assembled point clouds.

### BRIEF DESCRIPTION OF THE DRAWINGS

The following detailed description will be better understood when read in conjunction with the appended drawings, in which there are shown examples of one or more of the multiple embodiments of the present application. It should be understood, however, that the embodiments described herein are not limited to the precise arrangements and instrumentalities shown in the drawings. In the drawings:

FIG. 1 is a system diagram illustrating an example set of interfaces for a system according to some embodiments.

FIG. 2 is a process diagram illustrating an example attribute prediction by recoloring reference attribute according to some embodiments.

FIG. 3 is a schematic illustration showing example GPU threads and block according to some embodiments.

FIG. 4 is a schematic illustration showing an example GPU-based KNN search according to some embodiments.

FIG. 5 is a process diagram illustrating an example GPU-based recoloring according to some embodiments.

FIG. 6 is a process diagram illustrating an example partitioned GPU recoloring according to some embodiments.

FIG. 7 is a process diagram illustrating an example consecutive point cloud frame partitioning according to some embodiments.

FIG. 8 is a flowchart illustrating an example process for point cloud attribute recoloring method according to some embodiments.

FIG. 9 is a flowchart illustrating an example process for point cloud attribute recoloring method of predictive decoding according to some embodiments.

FIG. 10 is a flowchart illustrating an example process for point cloud attribute recoloring method of predictive encoding according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

In describing the various embodiments of the present application, certain terminology is used herein for convenience only and should not be considered as limiting such embodiments. In the drawings, the same reference numerals are employed for designating the same elements throughout the several figures and the present description.

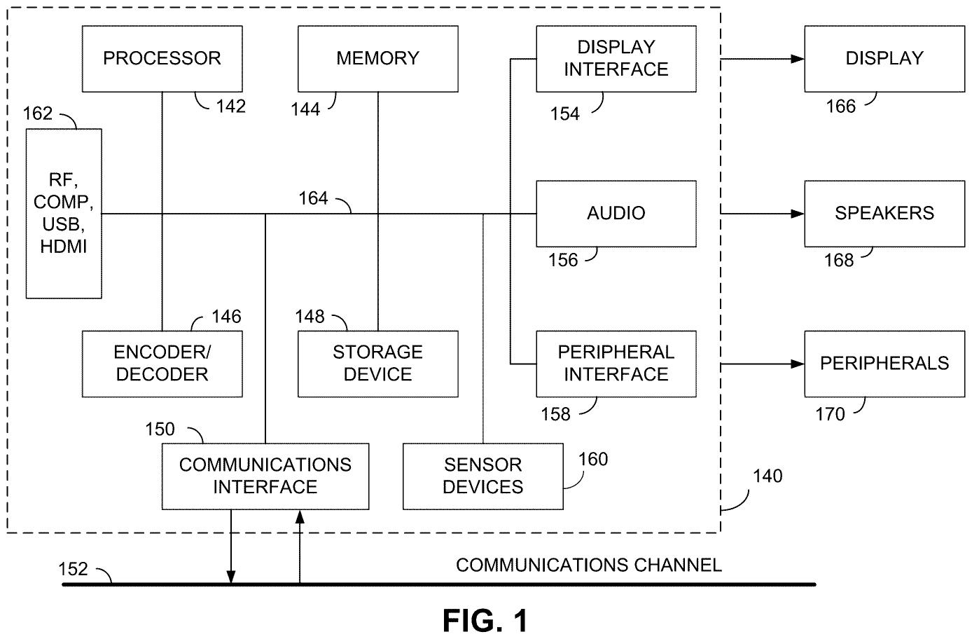

FIG. 1 is a system diagram illustrating an example set of interfaces for a system according to some embodiments. An extended reality display device, together with its control electronics, may be implemented using a system such as the system of FIG. 1. System 140 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 140, singly or in combination, can be embodied in a single integrated circuit (IC), multiple ICs, and/or discrete components. For example, in at least one embodiment, the processing and encoder/decoder elements of system 140 are distributed across multiple ICs and/or discrete components. In various embodiments, the system 140 is communicatively coupled to one or more other systems, or other electronic devices, via, for example, a communications bus or through dedicated input and/or output ports. In various embodiments, the system 140 is configured to implement one or more of the aspects described in this document.

The system 140 includes at least one processor 142 configured to execute instructions loaded therein for implementing, for example, the various aspects described in this document. Processor 142 may include embedded memory, input output interface, and various other circuitries as known in the art. The system 140 includes at least one memory 144 (e.g., a volatile memory device, and/or a non-volatile memory device). System 140 may include a storage device 148, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 148 can include an internal storage device, an attached storage device (including detachable and non-detachable storage devices), and/or a network accessible storage device, as non-limiting examples.

System 140 includes an encoder/decoder module 146 configured, for example, to process data to provide an encoded video or decoded video, and the encoder/decoder module 146 can include its own processor and memory. The encoder/decoder module 146 represents module(s) that can be included in a device to perform the encoding and/or decoding functions. As is known, a device can include one or both of the encoding and decoding modules. Additionally, encoder/decoder module 146 can be implemented as a separate element of system 140 or can be incorporated within processor 142 as a combination of hardware and software as known to those skilled in the art.

Program code to be loaded onto processor 142 or encoder/decoder 146 to perform the various aspects described in this document can be stored in storage device 148 and subsequently loaded onto memory 144 for execution by processor 142. In accordance with various embodiments, one or more of processor 142, memory 144, storage device 148, and encoder/decoder module 146 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 142 and/or the encoder/decoder module 146 is used to store instructions and to provide working memory for processing that is needed during encoding or decoding. In other embodiments, however, a memory external to the processing device (for example, the processing device can be either the processor 142 or the encoder/decoder module 142) is used for one or more of these functions. The external memory can be the memory 144 and/or the storage device 148, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 140 can be provided through various input devices as indicated in block 162. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1, include composite video.

In various embodiments, the input devices of block 162 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 140 to other electronic devices across USB and/or HDMI connections. It is to be understood that various aspects of input processing, for example, Reed-Solomon error correction, can be implemented, for example, within a separate input processing IC or within processor 142 as necessary. Similarly, aspects of USB or HDMI interface processing can be implemented within separate interface ICs or within processor 142 as necessary. The demodulated, error corrected, and demultiplexed stream is provided to various processing elements, including, for example, processor 142, and encoder/decoder 146 operating in combination with the memory and storage elements to process the datastream as necessary for presentation on an output device.

Various elements of system 140 can be provided within an integrated housing, Within the integrated housing, the various elements can be interconnected and transmit data therebetween using suitable connection arrangement 164, for example, an internal bus as known in the art, including the Inter-IC (12C) bus, wiring, and printed circuit boards.

The system 140 includes communication interface 150 that enables communication with other devices via communication channel 152. The communication interface 150 can include, but is not limited to, a transceiver configured to transmit and to receive data over communication channel 152. The communication interface 150 can include, but is not limited to, a modem or network card and the communication channel 152 can be implemented, for example, within a wired and/or a wireless medium.

Data is streamed, or otherwise provided, to the system 140, in various embodiments, using a wireless network such as a Wi-Fi network, for example IEEE 802.11 (IEEE refers to the Institute of Electrical and Electronics Engineers). The Wi-Fi signal of these embodiments is received over the communications channel 152 and the communications interface 150 which are adapted for Wi-Fi communications. The communications channel 152 of these embodiments is typically connected to an access point or router that provides access to external networks including the Internet for allowing streaming applications and other over-the-top communications. Other embodiments provide streamed data to the system 140 using a set-top box that delivers the data over the HDMI connection of the input block 162. Still other embodiments provide streamed data to the system 140 using the RF connection of the input block 162. As indicated above, various embodiments provide data in a non-streaming manner. Additionally, various embodiments use wireless networks other than Wi-Fi, for example a cellular network or a Bluetooth network.

The system 140 can provide an output signal to various output devices, including a display 166, speakers 168, and other peripheral devices 170. The display 166 of various embodiments includes one or more of, for example, a touchscreen display, an organic light-emitting diode (OLED) display, a curved display, and/or a foldable display. The display 166 can be for a television, a tablet, a laptop, a cell phone (mobile phone), or other device. The display 166 can also be integrated with other components (for example, as in a smart phone), or separate (for example, an external monitor for a laptop). The other peripheral devices 170 include, in various examples of embodiments, one or more of a stand-alone digital video disc (or digital versatile disc) (DVR, for both terms), a disk player, a stereo system, and/or a lighting system. Various embodiments use one or more peripheral devices 170 that provide a function based on the output of the system 140. For example, a disk player performs the function of playing the output of the system 140.

In various embodiments, control signals are communicated between the system 140 and the display 166, speakers 168, or other peripheral devices 170 using signaling such as AV.Link, Consumer Electronics Control (CEC), or other communications protocols that enable device-to-device control with or without user intervention. The output devices can be communicatively coupled to system 140 via dedicated connections through respective interfaces 154, 156, and 158. Alternatively, the output devices can be connected to system 140 using the communications channel 152 via the communications interface 150. The display 166 and speakers 168 can be integrated in a single unit with the other components of system 140 in an electronic device such as, for example, a television. In various embodiments, the display interface 154 includes a display driver, such as, for example, a timing controller (T Con) chip.

The display 166 and speaker 168 can alternatively be separate from one or more of the other components, for example, if the RF portion of input 162 is part of a separate set-top box. In various embodiments in which the display 166 and speakers 168 are external components, the output signal can be provided via dedicated output connections, including, for example, HDMI ports, USB ports, or COMP outputs.

The system 140 may include one or more sensor devices 160. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 140 is used as the control module for an extended reality display (such as control modules), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 142 or by hardware, or by a combination of hardware and software. As a non-limiting example, the embodiments can be implemented by one or more integrated circuits. The memory 144 can be of any type appropriate to the technical environment and can be implemented using any appropriate data storage technology, such as optical memory devices, magnetic memory devices, semiconductor-based memory devices, fixed memory, and removable memory, as non-limiting examples. The processor 142 can be of any type appropriate to the technical environment, and can encompass one or more of microprocessors, general purpose computers, special purpose computers, and processors based on a multi-core architecture, as non-limiting examples.

A User Equipment (UE) may correspond to any extended Reality (XR) device/node which may come in variety of form factors. Typical UE (e.g., XR UE) may include, but not limited to the following: Head Mounted Displays (HMD), optical see-through glasses and video see-through HMDs for Augmented Reality (AR) and Mixed Reality (MR), mobile devices with positional tracking and camera, wearables etc. In addition to the above, several different types of XR UE may be envisioned based on XR device functions for e.g., as display, camera, sensors, sensor processing, wireless connectivity, XR/Media processing, and power supply, to be provided by one or more devices, wearables, actuators, controllers and/or accessories. One or more device/nodes/UEs may be grouped into a collaborative XR group for supporting any of XR applications/experience/services.

### Point Cloud Data Format

The field of point cloud compression and processing aims to develop tools for compression, analysis, interpolation, representation and understanding of input signals, such as point clouds.

Point cloud data is a universal data format used across several business domains from autonomous driving, robotics, AR/VR, civil engineering, computer graphics, to the animation/movie industry. 3D LiDAR sensors have been deployed in self-driving cars, and affordable LiDAR sensors are released from Velodyne Velabit, Apple iPad Pro 2020 and Intel RealSense LiDAR camera L515. With advances in sensing technologies, 3D point cloud data becomes more practical than ever.

Point cloud data is also believed to consume a large portion of network traffic, e.g., among connected cars over 5G network, and immersive communications (VR/AR). Efficient representation formats may be necessary for point cloud understanding and communication. In particular, raw point cloud data may be organized and processed for the purposes of world modeling and sensing. Compression of raw point clouds may be used when storage and transmission of the data are used in related scenarios.

Furthermore, point clouds may represent a sequential scan of the same scene, which contains multiple moving objects. They are called dynamic point clouds, while static point clouds may be captured from a static scene or static objects. Dynamic point clouds are typically organized into frames, with different frames being captured at different times. Dynamic point clouds may require the processing and compression to be handled in real-time or with low delay.

### Point Cloud Data Use Cases

The automotive industry and autonomous car are domains in which point clouds may be used. Autonomous cars are able to “probe” their environment to make good driving decisions based on the reality of the immediate surroundings. Typical sensors, like LiDARs, produce (dynamic) point clouds that are used by the perception engine. These point clouds are not intended to be viewed by human eyes, and they are typically sparse, not necessarily colored, and dynamic with a high frequency of capture. They may have other attributes like the reflectance ratio provided by the LiDAR. This attribute may be indicative of the material of the sensed object, and this attribute may be used in making a decision.

Virtual Reality (VR) and immersive worlds have become a hot topic and are foreseen by many as the future of 2D flat video. The viewer is immersed in an environment all around the viewer, while in standard TV, the viewer may only look at the virtual world in front of the viewer. There are several gradations in the immersivity depending on the freedom of the viewer in the environment. Point clouds are a good format candidate to distribute VR worlds. They may be static or dynamic and are typically of average size, with, e.g., no more than millions of points at a time.

Point clouds also may be used for various purposes, such as cultural heritage/buildings, in which objects, like statues or buildings, are scanned in 3D to share the spatial configuration of the object without sending or visiting the statues or buildings. Also, point clouds offer a way to ensure preservation of knowledge of the object in case the original object, for instance, is destroyed by an earthquake. Such point clouds are typically static, colored, and huge.

Another use case is in topography and cartography in which, when using 3D representations, maps are not limited to the plane and may include the relief. Google Maps is a good example of 3D maps but is understood to use meshes instead of point clouds. Nevertheless, point clouds may be a suitable data format for 3D maps, and such point clouds are typically static, colored, and huge.

World modeling and sensing via point clouds may be a technology to allows machines to gain knowledge about the 3D world around them, which may be used by the applications discussed above.

3D point cloud data includes discrete samples on the surfaces of objects or scenes. A huge number of points may be used to fully represent the real world with point samples. For instance, a typical VR immersive scene contains millions of points, while point clouds typically contain hundreds of millions of points. Therefore, the processing of such large-scale point clouds may be computationally expensive, especially for consumer devices, such as smartphones, tablets, and automotive navigation systems, that have limited computational power.

The first step for processing or inference on the point cloud is to have efficient storage methodologies. To store and process the input point cloud with affordable computational cost, the point cloud may be down-sampled first, in which the down-sampled point cloud summarizes the geometry of the input point cloud while having much fewer points. The down-sampled point cloud may be inputted into a machine task for further processing. However, further reduction in storage space may be achieved by converting the raw point cloud data (original or down sampled) into a bitstream through entropy coding techniques for lossless compression.

In addition to lossless coding, many scenarios may use lossy coding for significantly improved compression ratios while maintaining the induced distortion under certain quality levels. To achieve a less lossy coding, an efficient point feature extractor may be used to improve the accuracy of the reconstruction within the given resource budget.

An additional challenge is to efficiently interpret the sparse nature of 3D point clouds compared to the regularly arranged 2D pixel samples of an image. To handle this issue, a sparse convolution method has been introduced. See Choy, C., et al., 4D Spatio-Temporal ConvNets: Minkowski Convolutional Neural Networks, IN PROC. OF IEEE/CVF CONF. ON COMP. VISION AND PATTERN RECOGNITION (CVPR) (June 2019). Based on these so-called sparse CNN, the learning-based point cloud compression (PCC) becomes an interesting topic in the computer vision and machine learning communities.

Transferring color information from one point cloud to another may be used for designing an efficient point cloud attribute coding framework. However, the point clouds to be coded are often complex and often consist of a large number of points. This problem may become more important if the recoloring becomes a normative process in the decoder. Therefore, complexity reduction and process optimization of the recoloring block may be used to achieve better attribute coding performance. A partitioned GPU recoloring on a predictive attribute coding pipeline may be used.

### Recoloring Function for Point Cloud Attribute Coding

Point cloud recoloring may be used to develop a point cloud compression (PCC) framework. A recoloring function transfers the attribute information from one geometry to another for the purpose of seamlessly processing attribute information throughout a PCC pipeline.

### Traditional Recoloring

Given a point cloud P_{A} with attribute (e.g., RGB) on a geometry (e.g., X, Y, Z) and another point cloud P_{B}, a recolor function transfers the attribute in P_{A} onto the geometry of P_{B}. A common approach is to search the K-Nearest Neighbors (KNN) from P_{B} to P_{A}. That means, for each point p_{b,j}∈ P_{B}, the K nearest points is found among the points p_{a,i}∈P_{A}, then store the indices i and distances dᵢ as the weighting information corresponding to the point p_{a,i}. These indices and distances are used to compute

$${\overline{p}}_{b , j}^{attr} ,$$

the weighted interpolation of the K nearest attributes from p_{b,j}. A recoloring equation with this distance-based weighted interpolation is defined as shown in Eq. 1:

$${\overline{p}}_{b , j}^{attr} = \frac{{\sum }_{i}^{K} {p}_{a , i}^{attr} / {d}_{i}}{{\sum }_{i}^{K} 1 / {d}_{i}} \\ where {p}_{a , i}^{attr} \qquad ( 1 )$$

is one of the K nearest attributes selected among the points in P_{A} and dᵢ is the distance from p_{a,i} to p_{b,j}. In some embodiments, dᵢ is the Euclidean distance between p_{a,i} to p_{p,j}. In some embodiments, dᵢ is the Manhattan distance.

To further increase the recoloring quality, another KNN search from P_{A} to P_{B} may be additionally processed (a two-way KNN). For this second stage of KNN searching, additional factors

$${p}_{a , i}^{attr} / {d}_{i}$$

and 1/dᵢ are accumulated for each numerator and denominator, respectively, for the recoloring of the corresponding point p_{b,j}. The final weighted attributes of each point

$${\overline{p}}_{b , j}^{attr} ∈ {P}_{B}$$

is the output of the recoloring process.

The computational cost becomes more and more problematic as the size of P_{A} and P_{B} increases. To address this problem, a k-d tree may be used to ease the burden of searching by constructing a balanced tree in advance, then reducing the number of the distance computation by efficiently pruning the non-necessary points by traversing the tree when searching the nearest neighbors of the given query point. See Bentley, J. L., Multidimensional Binary Search Trees Used for Associative, 18:9 COMMUNICATIONS OF ACM 509-517 (1975).

The recoloring method described in this section is broadly used and processed on a CPU since some computational processes, such as tree traversal, may not be suitable for GPU-based multi-processing.

This application introduces a point cloud recoloring method for (but not limited to) attribute coding.

Point cloud partitioning is combined with GPU-based recoloring to speed up the encoding or decoding processes without loss of attribute reconstruction qualities. This methodology may be especially useful for a predictive attribute encoding and decoding, where the recoloring in decoder is a normative process. More details on the recoloring method in the decoder is described below.

Point cloud recoloring is a time-consuming process that is used in many attribute coding frameworks. A CPU-based recoloring process supported by k-d tree traversal may improve the performance of KNN searching (a base function for recoloring) by pruning out un-necessary distance computations between point clouds. However, the rapid development of graphics hardware along with active evolution of AI technologies, opens the door to investigate new ways of computing the recoloring process. As such, this application presents a GPU-based recoloring process enhanced with a partitioning of point cloud(s). For a GPU-based KNN search, a massive multi-processing block is run in the GPU by assigning each point from a querying point cloud to a thread. The points in the other point cloud are stored in a shared memory to complete a block in a GPU. The distance computations between these two sub-point clouds are computed at once. A large amount of these blocks are also computed in parallel, making a highly efficient parallel computation of GPU-based KNN search. Moreover, to further enhance the performance, both point clouds are partitioned by applying a slicing parameter. The partitioning is processed by the given slicing parameter, then a set of partitioning boundary parameters are extracted to achieve a well-balanced partitioning. This “partitioned GPU recoloring” process is applied to predictive point cloud attribute encoder and decoder frameworks, and significant improvements may be observed in both encoding and decoding times.

### Recoloring for Predictive Attribute Decoding

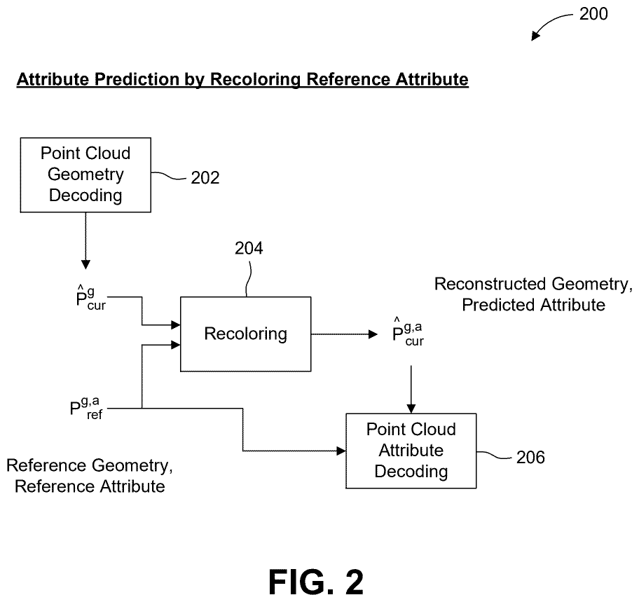

FIG. 2 is a process diagram illustrating an example attribute prediction by recoloring reference attribute according to some embodiments. FIG. 2 shows a recoloring block 204 in a point cloud attribute decoding pipeline 200. In this predictive decoder, the point cloud geometry is reconstructed as

$${\hat{P}}_{cur}^{g}$$

by a point cloud geometry decoding block 202. The previously-decoded frames

$${P}_{ref}^{g , a} and {\hat{P}}_{cur}^{g}$$

are processed through a recoloring block 204. The recoloring block 204 outputs a predicted attribute,

$${\hat{P}}_{cur}^{g , a} ,$$

in which the attribute is recolored on top of the reconstructed geometry

$${\hat{P}}_{cur}^{g} .$$

the reference and predicted point clouds, both with attributes, are inputted to the point cloud attribute decoding block 206. In some embodiments, the recolor function is a traditional recoloring method. The process around the recoloring block 204 in the encoder may be identical to the process around a recoloring block in the decoder. The recoloring block 204 in FIG. 2 is a normative process

Within this framework, the recoloring block 204 is further enhanced by replacing the recoloring block 204 with a GPU-based recoloring and splitting process, which partitions the pair of point cloud frames (the reconstructed and reference point clouds). The details of the GPU-based recoloring and partitioning method are described below.

### GPU-Based KNN Search

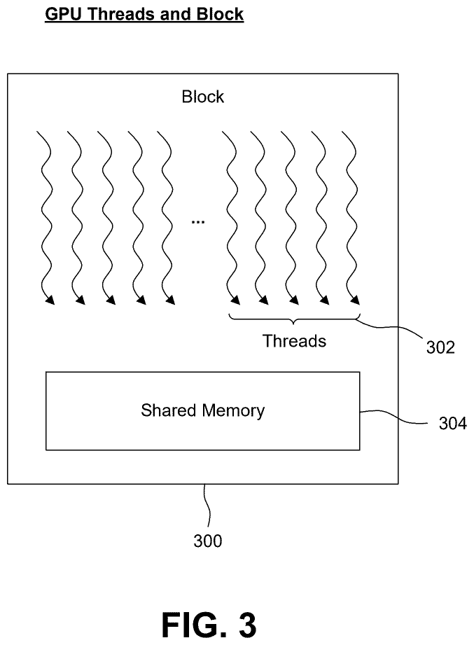

FIG. 3 is a schematic illustration showing example GPU threads and block according to some embodiments. A Graphics Processing Unit (GPU) is very powerful for computing repetitive tasks in parallel. A computing platform with a large number of multi-processing blocks and threads allows highly efficient distance computation between two heavy point clouds. As illustrated in FIG. 3, a block 300 of, e.g., around 1024 threads 302 running in parallel with all of the threads within the same block is available to access a shared memory 304.

In practice, the performance of a GPU-based KNN search that computes all point-to-point combinations between two point clouds may still outperform the CPU-based method with a k-d tree traversal, though such performance depends on the size of the point cloud.

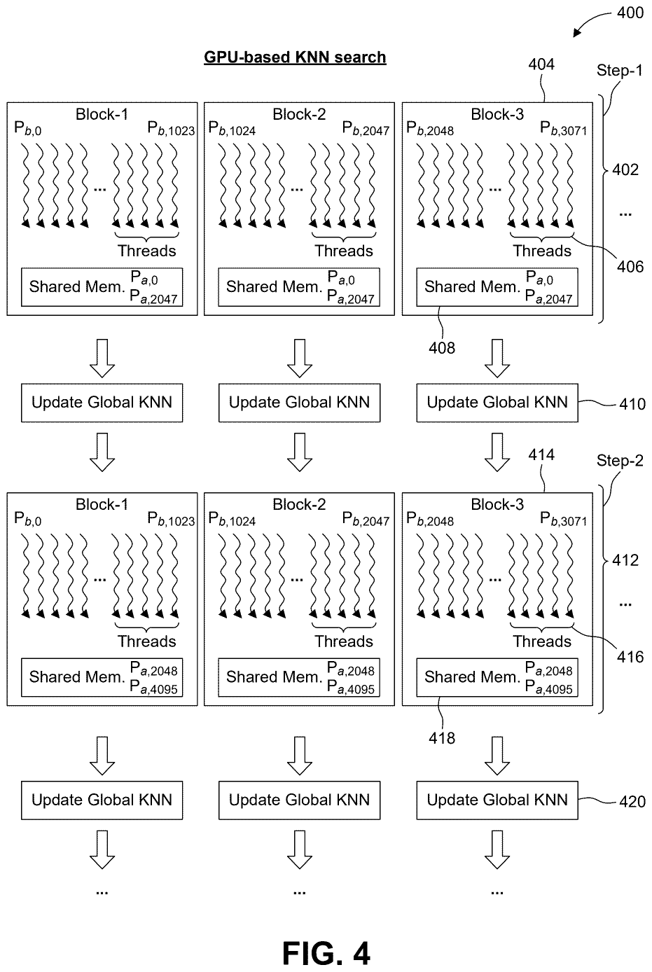

FIG. 4 is a schematic illustration showing an example GPU-based KNN search according to some embodiments. An example GPU-based KNN search 400 is processed as shown in FIG. 4. Given two point clouds P_{A} and P_{B}, the KNN search 400 from P_{B} to P_{A} starts by assigning p_{b,j} (each point in P_{B}) to each thread 406, 416. If the size of the block is limited, then the thread assigning continues to the next block. If the block reaches the maximum multi-processing capability, then the remaining points p_{b,j} wait until any current running threads 406, 416 are released for a new assignment.

For each block 404, 414, a set of points p_{a,i} (a set of points among the points in P_{A}) are also registered in the shared memory 408, 414. For example, in Block-1, 2048 points in P_{A} (P_{a,{0, . . . , 2047}}) are stored for computing the distance one-by-one against each point p_{b,j} assigned to the thread. For each thread, local KNN information (i^{l} and d^{l}—a list of KNN's indices from the points in the shared memory 408 and a list of corresponding distances, respectively) are updated in step 1 (402). Once all the threads 406 in a block 404 finish their tasks, each local KNN information is updated 410 to the corresponding global KNN lists (i for indices and d for corresponding distances). Then, in step 2 (412), the shared memory 418 is updated with the next 2048 points, P_{a,{2048, . . . , 4095}}. Once all the threads 416 in a block 414 finish their tasks for step 2 (412), each local KNN information is updated 420 to the corresponding global KNN lists (i for indices and d for corresponding distances). The steps continue until all the points in P_{A} are processed.

The tree traversal may not be efficient in GPU-based KNN search since the process is not heterogeneous, which means that the multi-processing will be hard to synchronize.

### GPU-Based Recoloring

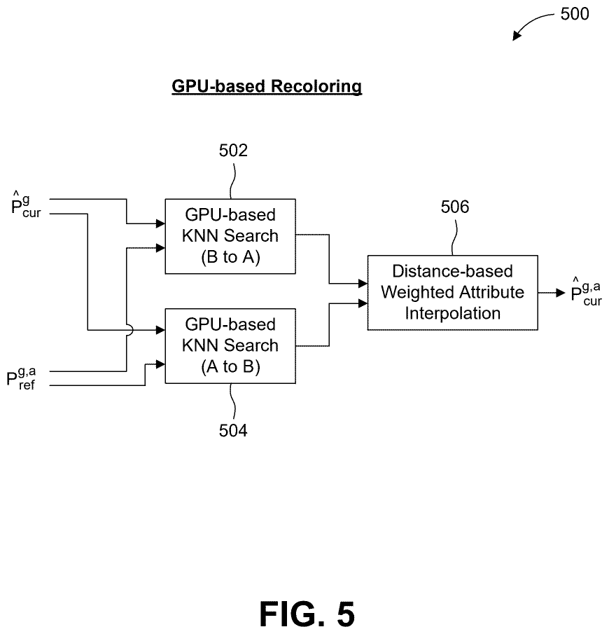

FIG. 5 is a process diagram illustrating an example GPU-based recoloring according to some embodiments. The final i and d will be used to compute the distance-based weighted interpolation as described in Eq. 1. As depicted in FIG. 5, the GPU-based KNN search is performed for both directions: from A to B (504) and from B to A (502), where A is

$${P}_{ref}^{g , a} ,$$

### and B is

$${\hat{P}}_{cur}^{g} .$$

the global KNN lists obtained for each KNN search are gathered to compute the weighted interpolated attribute via the distance-based weighted attribute interpolation 506 to finalize the process 500 of the GPU-based recoloring.

### Partitioned GPU Recoloring

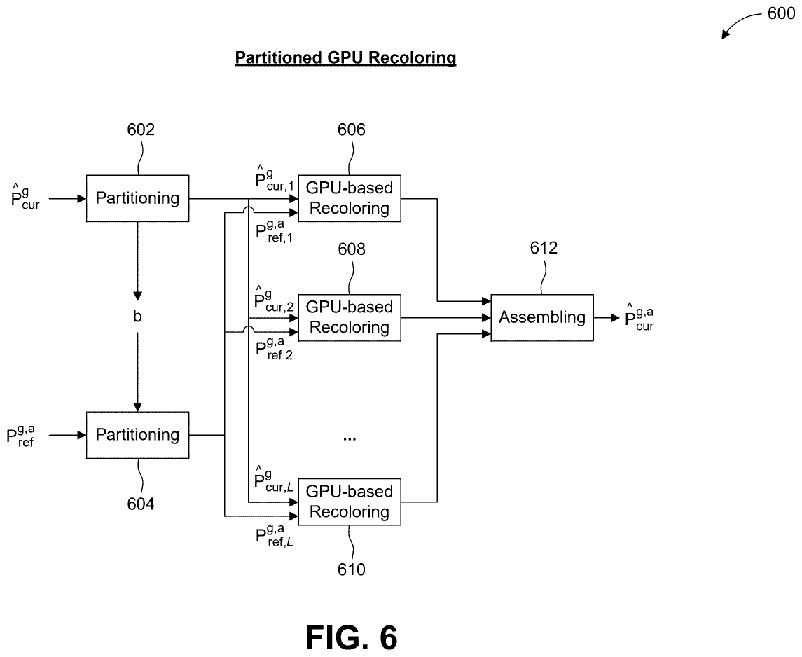

FIG. 6 is a process diagram illustrating an example partitioned GPU recoloring according to some embodiments. The performance of the GPU-based recoloring is dependent on the size of the input point clouds. Since a balanced tree is not constructed for searching nearest neighbors, the recoloring on larger point clouds may be relatively slower.

To address this observation and to further enhance the recoloring process, a partitioned GPU recoloring may be performed. As depicted in the process 600 of FIG. 6, the reconstructed point cloud

$${\hat{P}}_{cur}^{g}$$

and the reference point cloud

$${P}_{ref}^{g , a}$$

are both partitioned with equal boundary parameters b. A slicing parameter s is given for each partitioning block 602, 604. More details on partitioning are given below.

Each partitioning block 602, 604 outputs L partitioned point clouds,

$${\hat{P}}_{cur , \{ 1 , … , L \}}^{g} and {P}_{ref , \{ 1 , … , L \}}^{g , a} .$$

A pair of partitioned point clouds, e.g.,

$${\hat{P}}_{cur , 2}^{g} and {P}_{ref , 2}^{g , a} ,$$

are sent to the GPU-based recoloring block 606, 608, 610. Each partition pair is processed through independent GPU-based recoloring blocks 606, 608, 610, which output a partitioned/recolored point cloud, e.g.,

$${\hat{P}}_{cur , 2}^{g , a} .$$

All the partitioned/recolored point clouds

$${\hat{P}}_{cur , \{ 1 , … , L \}}^{g , a}$$

are assembled 612 to obtain a full recolored point cloud

$${\hat{P}}_{{cur}^{*}}^{g , a}$$

Paired Frame Partitioning with Slice

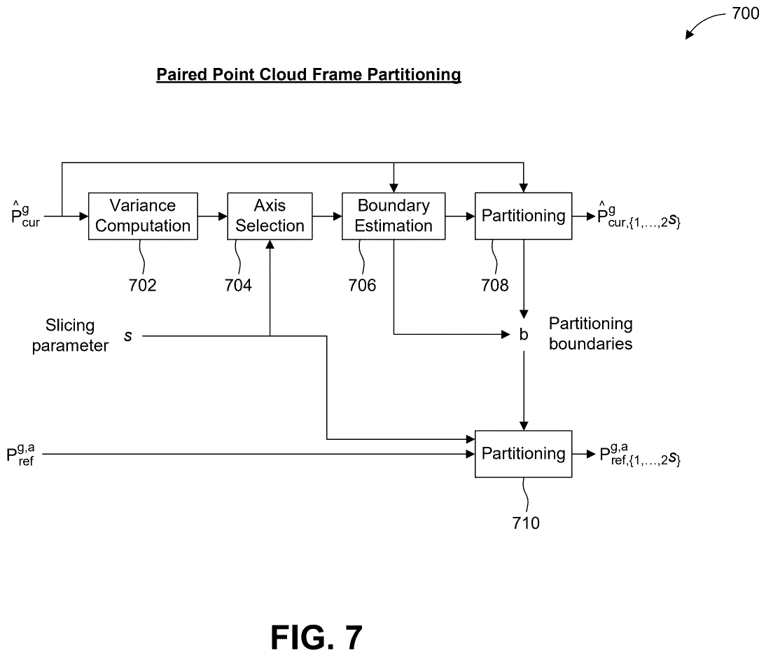

FIG. 7 is a process diagram illustrating an example consecutive point cloud frame partitioning according to some embodiments. As illustrated in the process 700 of FIG. 7, a pair of point cloud frames, e.g.,

$${\hat{P}}_{cur}^{g} and {P}_{ref}^{g , a} ,$$

are partitioned. Given a slicing parameter s (0≤s≤3), each point cloud

$${\hat{P}}_{cur}^{g} or {P}_{ref}^{g , a}$$

is partitioned into 2^{s} partitioned point clouds. The reconstructed point cloud

$${\hat{P}}_{cur}^{g}$$

are partitioned as described below.

$${\hat{P}}_{cur}^{g}$$

is passed to the variance computation block 702, which computes the variance of the point cloud geometry along the x, y, and z axes, leading to 3 variance values,

$${σ}_{x}^{2} , {σ}_{y}^{2} , and {σ}_{Z}^{2} .$$

Based on the variance values, the axis selection block 704 picks s (0≤s≤3) axes. Particularly, the axis selection block 704 picks s axes with the largest variance values. For instance, if s=1, then only one of the x, y, and z axes with largest variance will be picked.

$${\hat{P}}_{cur}^{g}$$

will be partitioned along the picked axis. To indicate whether an axis is selected, a binary flag is used for indication. There are three binary flags in total, denoted as fₓ, f_{y}, and f_{z}, corresponding to the x, y, and z axes, respectively. Together they form a vector f, which is the output of the axis selection 704 block.

The boundary estimation block 706 estimates the partitioning boundary along each selected axis. The boundary estimation block 706 tries to estimate boundaries that splits the point cloud equally (or approximately equal numbers of points) for the purpose of generating balanced partitions. If the x axis is picked, then the boundary estimation block 706 computes the 50^{th} percentile of the point cloud along the x axis. The value of the 50^{th} percentile gives the slicing boundary bₓ along the x axis. If the x axis is not picked, the boundary estimation block 706 directly sets the slicing boundary bₓ=0 to signal that the axis x is not picked, and no partition boundary is computed. This process repeats for all axes, and all the boundaries together form a vector b. In the special case where s=0, the boundary estimation block 706 outputs b=[0, 0, 0].

The partitioning block 708 takes

$${\hat{P}}_{cur}^{g}$$

and the partitioning boundaries b as inputs and partitions

$${\hat{P}}_{cur}^{g}$$

into several partitions.

$${\hat{P}}_{cur , \{ 1 , … , {2}^{s} \}}^{g}$$

is an output of the partitioning block 708.

The partitioning block 710 takes the partitioning boundaries b as inputs and partitions the given point cloud into 2^{s} partitions along the selected axes at the estimated boundaries. To achieve the paired partitioning, the reference point cloud

$${P}_{ref}^{g , a}$$

does not need to go through boundary estimation process. The partitioning block 710 takes b as an input to partition

$${P}_{ref}^{g , a}$$

into partitions

$${P}_{ref , \{ 1 , … , {2}^{s} \}}^{g}$$

In some embodiments, the partitioning order for

$${\hat{P}}_{cur}^{g} or {P}_{ref}^{g , a}$$

is swapped. In this case, the boundary estimation is done with the reference point cloud

$${P}_{ref}^{g , a}$$

as an input. In this case, the signaling of the slice parameter is not required for the inter frame.

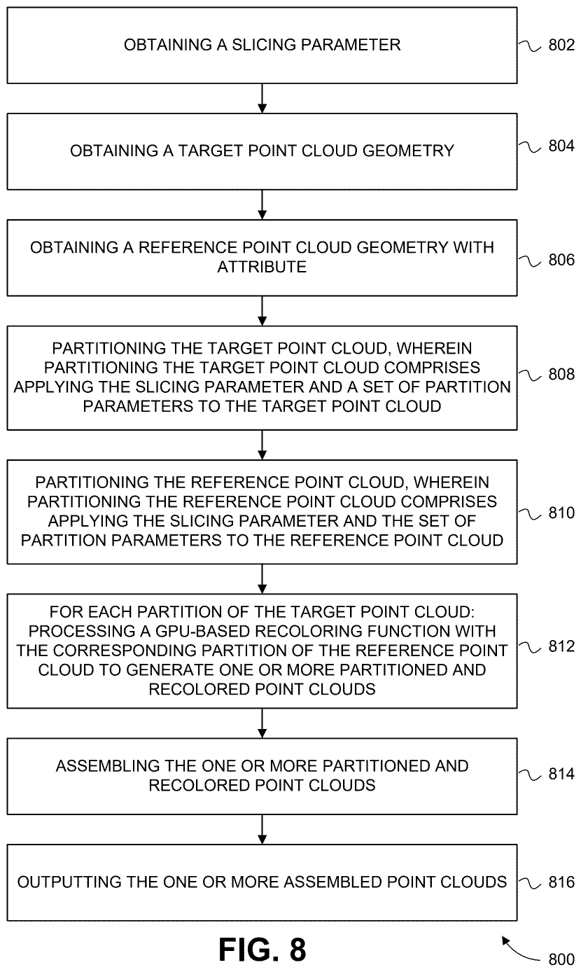

FIG. 8 is a flowchart illustrating an example process for point cloud attribute recoloring method according to some embodiments. For some embodiments, an example process 800 may include obtaining 802 a slicing parameter. For some embodiments, the example process 800 may further include obtaining 804 a target point cloud geometry. For some embodiments, the example process 800 may further include obtaining 806 a reference point cloud geometry with attribute. For some embodiments, the example process 800 may further include partitioning 808 the target point cloud, wherein partitioning the target point cloud comprises applying the slicing parameter and a set of partition parameters to the target point cloud. For some embodiments, the example process 800 may further include partitioning 810 the reference point cloud, wherein partitioning the reference point cloud comprises applying the slicing parameter and the set of partition parameters to the reference point cloud. For some embodiments, the example process 800 may further include for each partition of the target point cloud: processing 812 a GPU-based recoloring function with the corresponding partition of the reference point cloud to generate one or more partitioned and recolored point clouds. For some embodiments, the example process 800 may further include assembling 814 the one or more partitioned and recolored point clouds. For some embodiments, the example process 800 may further include outputting 816 the one or more assembled point clouds.

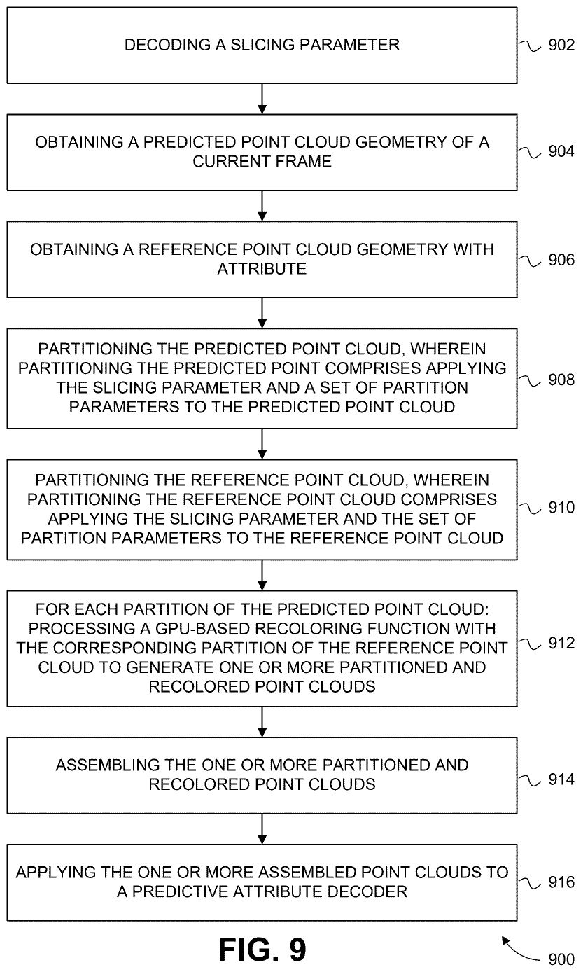

FIG. 9 is a flowchart illustrating an example process for point cloud attribute recoloring method of predictive decoding according to some embodiments. For some embodiments, an example process 900 may include decoding 902 a slicing parameter. For some embodiments, the example process 900 may further include obtaining 904 a predicted point cloud geometry of a current frame. For some embodiments, the example process 900 may further include obtaining 906 a reference point cloud geometry with attribute. For some embodiments, the example process 900 may further include partitioning 908 the predicted point cloud, wherein partitioning the predicted point comprises applying the slicing parameter and a set of partition parameters to the predicted point cloud. For some embodiments, the example process 900 may further include partitioning 910 the reference point cloud, wherein partitioning the reference point cloud comprises applying the slicing parameter and the set of partition parameters to the reference point cloud. For some embodiments, the example process 900 may further include for each partition of the predicted point cloud: processing 912 a GPU-based recoloring function with the corresponding partition of the reference point cloud to generate one or more partitioned and recolored point clouds. For some embodiments, the example process 900 may further include assembling 914 the one or more partitioned and recolored point clouds. For some embodiments, the example process 900 may further include applying 916 the one or more assembled point cloud to a predictive attribute decoder.

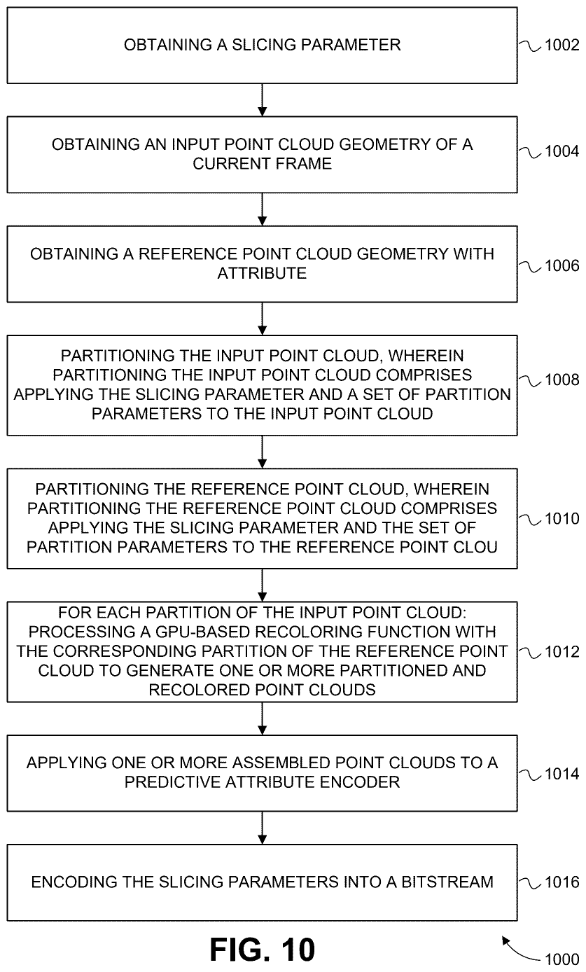

FIG. 10 is a flowchart illustrating an example process for point cloud attribute recoloring method of predictive encoding according to some embodiments. For some embodiments, an example process 1000 may include obtaining 1002 a slicing parameter. For some embodiments, the example process 1000 may further include obtaining 1004 an input point cloud geometry of a current frame. For some embodiments, the example process 1000 may further include obtaining 1006 a reference point cloud geometry with attribute. For some embodiments, the example process 1000 may further include partitioning 1008 the input point cloud, wherein partitioning the input point cloud comprises applying the slicing parameter and a set of partition parameters to the input point cloud. For some embodiments, the example process 1000 may further include partitioning 1010 the reference point cloud, wherein partitioning the reference point cloud comprises applying the slicing parameter and the set of partition parameters to the reference point cloud. For some embodiments, the example process 1000 may further include for each partition of the input point cloud: processing 1012 a GPU-based recoloring function with the corresponding partition of the reference point cloud to generate one or more partitioned and recolored point clouds. For some embodiments, the example process 1000 may further include applying 1014 one or more assembled point clouds to a predictive attribute encoder. For some embodiments, the example process 1000 may further include encoding 1006 the slicing parameters into a bitstream.

An example apparatus in accordance with some embodiments may include at least one processor configured to perform any one of the methods described within this application. An example apparatus in accordance with some embodiments may include a computer-readable medium storing instructions for causing one or more processors to perform any one of the methods described within this application. An example apparatus in accordance with some embodiments may include at least one processor and at least one non-transitory computer-readable medium storing instructions for causing the at least one processor to perform any one of the methods described within this application. An example signal in accordance with some embodiments may include a bitstream generated according to any one of the methods described within this application.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

An example method in accordance with some embodiments may include: obtaining a slicing parameter; obtaining a target point cloud geometry; obtaining a reference point cloud geometry with attribute; partitioning the target point cloud, wherein partitioning the target point cloud includes applying the slicing parameter and a set of partition parameters to the target point cloud; partitioning the reference point cloud, wherein partitioning the reference point cloud includes applying the slicing parameter and the set of partition parameters to the reference point cloud; for each partition of the target point cloud: processing a GPU-based recoloring function with the corresponding partition of the reference point cloud to generate one or more partitioned and recolored point clouds; assembling the one or more partitioned and recolored point clouds; and outputting the one or more assembled point clouds.

Some embodiments of the example method may further include generating the set of partition parameters.

For some embodiments of the example method, partitioning the reference point cloud is performed before partitioning the target point cloud.

For some embodiments of the example method, obtaining the slicing parameter includes decoding the slicing parameter.

For some embodiments of the example method, wherein obtaining the slicing parameter includes obtaining a bitstream, and wherein the bitstream includes the slicing parameter.

For some embodiments of the example method, the target point cloud geometry includes at least one of: a predicted point cloud geometry of a current frame, a reconstructed point cloud geometry of the current frame, and an input point cloud geometry of the current frame.

Some embodiments of the example method may further include applying the one or more assembled point clouds to a predictive attribute decoder.

Some embodiments of the example method may further include: applying the one or more assembled point clouds to a predictive attribute encoder; and encoding the slicing parameters into a bitstream

For some embodiments of the example method, processing, for each partition of the target point cloud, the GPU-based recoloring function with the corresponding partition of the reference point cloud includes: splitting the GPU-based recoloring function into a series of split GPU-based recoloring functions corresponding respectively to the partitions of the reference point cloud; and generating a partitioned and recolored point cloud for each partition of the target point cloud.

For some embodiments of the example method, partitioning the reference point cloud includes: inputting the reference point cloud, the slicing parameter, and the set of partition parameters into a partitioning process; and partitioning the reference point cloud into a set of partitioned reference point clouds, wherein the slicing parameter indicates quantity of partitioned reference point clouds.

For some embodiments of the example method, partitioning the target point cloud includes: computing variance of geometry of the target point cloud; selecting boundary axes for the target point cloud using the computed variance; estimating boundaries for the target point cloud based on the selected boundary axes; and partitioning the target point cloud based on the estimated boundaries.

For some embodiments of the example method, computing variance of geometry of the target point cloud computes variance along x, y, and z axes of the target point cloud.

For some embodiments of the example method, selecting boundary axes includes selecting boundary axes corresponding to computed variances above a threshold.

For some embodiments of the example method, estimating boundaries for the target point cloud includes: determining a 50th percentile value along at least one of the selected axes, wherein the 50th percentile value splits the target point cloud into approximately equal numbers of points.

For some embodiments of the example method, partitioning the target point cloud includes: partitioning the target point cloud into a set of partitioned target point clouds, wherein the slicing parameter indicates quantity of partitioned target point clouds.

For some embodiments of the example method, the slicing parameter is an integer equal to 0, 1, 2, or 3.

For some embodiments of the example method, the GPU-based recoloring function includes: performing a first GPU-based nearest neighbor search from the reference point cloud to the target point cloud; performing a second GPU-based nearest neighbor search from the target point cloud to the reference point cloud; and performing a distance-based weighted attribute interpolation using nearest neighbor lists generated by the first and second GPU-based nearest neighbor searches.

For some embodiments of the example method, each of the first and second GPU-based nearest neighbor searches includes splitting each of the first and second searches to a plurality of sets of threads based on number of points to search in the target and reference point clouds.

For some embodiments of the example method, splitting each of the first and second searches to the plurality of sets of threads generates sets of threads of approximately equal size.

An example apparatus in accordance with some embodiments may include: a processor; and a memory storing instructions operative, when executed by the processor, to cause the apparatus to: obtain a slicing parameter; obtain a target point cloud geometry; obtain a reference point cloud geometry with attribute; partition the target point cloud, wherein partitioning the target point cloud includes applying the slicing parameter and a set of partition parameters to the target point cloud; partition the reference point cloud, wherein partitioning the reference point cloud includes applying the slicing parameter and the set of partition parameters to the reference point cloud; for each partition of the target point cloud: process a GPU-based recoloring function with the corresponding partition of the reference point cloud to generate one or more partitioned and recolored point clouds; assemble the one or more partitioned and recolored point clouds; and output the one or more assembled point clouds.

One or more embodiments provide a computer program including instructions which when executed by one or more processors cause such processors to perform the encoding and/or decoding methods according to any of the embodiments described above. One or more embodiments also provide a computer readable storage medium having stored thereon instructions for encoding or decoding video data according to the methods described above.

One or more embodiments provide a computer readable storage medium having stored thereon video data generated according to the methods described above. One or more embodiments also provide a method and apparatus for transmitting or receiving video data generated according to the methods described above.

The embodiments described herein may be implemented in, for example, a method or a process, an apparatus, a software program, a data stream, or a signal. Even if only discussed in the context of a single form of implementation (e.g., as a method), the implementation of such features may also be implemented in other forms. An apparatus may be implemented in, for example, appropriate hardware, software, and firmware. Corresponding methods may be implemented in, for example, a processor.

Various numeric values are used in the present application. Such specific values are for example purposes and the embodiments described are not limited to these specific values.

Various methods are described herein, and such methods include one or more steps or actions for achieving the described method. Unless a specific order of steps or actions is required for the proper operation of the method, the order and/or use of specific steps and/or actions may be modified or combined. Additionally, terms such as “first”, “second”, etc. may be used in various embodiments to modify an element, component, step, operation, etc., for example, a “first decoding” and a “second decoding”. Use of such terms does not imply an order to the operations unless specifically required.

The present application may refer to “determining” various pieces of information. Determining information may include one or more of, for example, estimating, calculating, predicting, or retrieving (e.g., from memory) the information.

The present application may refer to “accessing” various pieces of information. Accessing information may include one or more of, for example, receiving, retrieving (e.g., from memory), storing, moving, copying, calculating, determining, predicting, or estimating the information. Similarly, the present application may refer to “receiving” various pieces of information. Receiving information may include one or more of, for example, accessing or retrieving (e.g., from memory) the information.

It is to be understood that use of any of the following “/”, “and/or”, and “at least one of” is intended to encompass all possible selections of listed items, taken either individually or in any combination thereof.

While specific embodiments have been described in the foregoing description in connection with the accompanying drawings, it should be understood that embodiments described herein are examples only and should not be taken as limiting the scope of the present application or the following claims. Although features and elements are described herein in particular combinations, those of ordinary skill in the art will appreciate that such features or elements may be used alone or in any combination with the other features and elements. It is understood, therefore, that the overall teachings of the present application are not limited to the particular embodiments, implementations, and examples disclosed herein, but are intended to cover variations, modifications, and alternatives as defined by the appended claims and any and all equivalents thereof.

This application describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the application or scope of those aspects. Indeed, all of the different aspects can be combined and interchanged to provide further aspects. Moreover, the aspects can be combined and interchanged with aspects described in earlier filings as well.

Various numeric values may be used in the present application, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information can include one or more of, for example, estimating the information, calculating the information, predicting the information, or retrieving the information from memory.

Further, this application may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A point cloud attribute recoloring method, comprising:
obtaining a slicing parameter;
obtaining a target point cloud geometry;
obtaining a reference point cloud geometry with attribute;
partitioning the target point cloud,
wherein partitioning the target point cloud comprises applying the slicing parameter and a set of partition parameters to the target point cloud;
partitioning the reference point cloud,
wherein partitioning the reference point cloud comprises applying the slicing parameter and the set of partition parameters to the reference point cloud;
for each partition of the target point cloud:
processing a GPU-based recoloring function with the corresponding partition of the reference point cloud to generate one or more partitioned and recolored point clouds;
assembling the one or more partitioned and recolored point clouds; and
outputting the one or more assembled point clouds.

2. The method of claim 1, further comprising generating the set of partition parameters.

3. The method of claim 1, wherein partitioning the reference point cloud is performed before partitioning the target point cloud.

4. The method of claim 1, wherein obtaining the slicing parameter comprises decoding the slicing parameter.

5. The method of claim 1,
wherein obtaining the slicing parameter comprises obtaining a bitstream, and
wherein the bitstream comprises the slicing parameter.

6. The method of claim 1, wherein the target point cloud geometry comprises at least one of: a predicted point cloud geometry of a current frame, a reconstructed point cloud geometry of the current frame, and an input point cloud geometry of the current frame.

7. The method of claim 1, further comprising applying the one or more assembled point clouds to a predictive attribute decoder.

8. The method of claim 1, further comprising:
applying the one or more assembled point clouds to a predictive attribute encoder; and
encoding the slicing parameters into a bitstream.

9. The method of claim 1, wherein processing, for each partition of the target point cloud, the GPU-based recoloring function with the corresponding partition of the reference point cloud comprises:
splitting the GPU-based recoloring function into a series of split GPU-based recoloring functions corresponding respectively to the partitions of the reference point cloud; and
generating a partitioned and recolored point cloud for each partition of the target point cloud.

10. The method of claim 1, wherein partitioning the reference point cloud comprises:
inputting the reference point cloud, the slicing parameter, and the set of partition parameters into a partitioning process; and
partitioning the reference point cloud into a set of partitioned reference point clouds,
wherein the slicing parameter indicates quantity of partitioned reference point clouds.

11. The method of claim 1, wherein partitioning the target point cloud comprises:
computing variance of geometry of the target point cloud;
selecting boundary axes for the target point cloud using the computed variance;
estimating boundaries for the target point cloud based on the selected boundary axes; and
partitioning the target point cloud based on the estimated boundaries.

12. The method of claim 11, wherein computing variance of geometry of the target point cloud computes variance along x, y, and z axes of the target point cloud.

13. The method of claim 11, wherein selecting boundary axes comprises selecting boundary axes corresponding to computed variances above a threshold.

14. The method of claim 11, wherein estimating boundaries for the target point cloud comprises:
determining a 50th percentile value along at least one of the selected axes,
wherein the 50th percentile value splits the target point cloud into approximately equal numbers of points.

15. The method of claim 11, wherein partitioning the target point cloud comprises:
partitioning the target point cloud into a set of partitioned target point clouds,
wherein the slicing parameter indicates quantity of partitioned target point clouds.

16. The method of claim 1, wherein the slicing parameter is an integer equal to 0, 1, 2, or 3.

17. The method of claim 1, wherein the GPU-based recoloring function comprises:
performing a first GPU-based nearest neighbor search from the reference point cloud to the target point cloud;
performing a second GPU-based nearest neighbor search from the target point cloud to the reference point cloud; and
performing a distance-based weighted attribute interpolation using nearest neighbor lists generated by the first and second GPU-based nearest neighbor searches.

18. The method of claim 17, wherein each of the first and second GPU-based nearest neighbor searches comprises splitting each of the first and second searches to a plurality of sets of threads based on number of points to search in the target and reference point clouds.

19. The method of claim 18, wherein splitting each of the first and second searches to the plurality of sets of threads generates sets of threads of approximately equal size.

20. An apparatus comprising:
a processor; and
a memory storing instructions operative, when executed by the processor, to cause the apparatus to:
obtain a slicing parameter;
obtain a target point cloud geometry;
obtain a reference point cloud geometry with attribute;
partition the target point cloud,
wherein partitioning the target point cloud comprises applying the slicing parameter and a set of partition parameters to the target point cloud;
partition the reference point cloud,
wherein partitioning the reference point cloud comprises applying the slicing parameter and the set of partition parameters to the reference point cloud;
for each partition of the target point cloud:
process a GPU-based recoloring function with the corresponding partition of the reference point cloud to generate one or more partitioned and recolored point clouds;
assemble the one or more partitioned and recolored point clouds; and
output the one or more assembled point clouds.
